(19) United States
(12) Patent Application Publication
(10) Pub. No.: US 2011/0208427 A1
(43) Pub. Date: Aug. 25, 2011

(54) Location Identification Systems and Methods

(75) Inventors: William L. Jansen, Bloomington, MN (US); Peter S. Brennan, Lakeville, MN (US)

(73) Assignee: Peter S. Brennan, Lakeville, MN (US)

(21) Appl. No.: 13/016,193

(22) Filed: Jan. 28, 2011

Related U.S. Application Data
(60) Provisional application No. 61/308,022, filed on Feb. 25, 2010.

(51) Int. Cl. G01C 21/20

(52) U.S. Cl. 701/208

(57) ABSTRACT

Embodiments provide systems and methods for identifying one or more locations in a selected geographic region of interest. In certain cases a processor-executed method for generating location identification codes is provided. The method includes receiving information about a selected geographic region, a standard areal unit, and a predetermined set of characters, and then generating one or more location identification codes after determining the total number of areal units in the region and the number of character positions in the code. An interactive mapping system includes inputs/outputs, memory, and a processor programmed to receive a location identification code, retrieve and display a location description for verification, and retrieve and display map data corresponding to the location identification code.

### CROSS-REFERENCES

This application claims the benefit of U.S. Provisional Application No. 61/308,022, filed Feb. 25, 2010, the content of which is hereby incorporated by reference in its entirety.

### BACKGROUND

Embodiments of the present invention generally relate to systems and methods for referencing locations within a geographic region of interest. More particularly, embodiments of the invention relate to systems and methods for generating unique location identification codes useful for referencing specific locations within the geographic region of interest.

Interactive, computer-based mapping systems and services are well known and provide an enhanced level of usability and customization when compared with the use of traditional static maps (e.g., in physical and/or digital form). Internet-based mapping applications, such as MapQuest, Google Maps, Yahoo Maps, and the like, are one familiar example of computer-based mapping systems. Upon entering a desired location(s), the applications are typically able to display a plethora of information corresponding to the entered location, including multiple types of customizable maps and/or driving directions. GPS (global positioning system) navigation systems are another well known example of an interactive mapping system that provides enhanced mapping capabilities. The popularity of such systems, and the increased mapping capabilities they provide, has increased dramatically over the past few years. For example, GPS navigation unit sales rose four-fold over the past four years, rising from approximately $1.1 billion in sales in 2006, to expected sales of $4.5 billion in 2009.

Geographic location data is typically manually entered into interactive mapping systems. The forms of data entry can vary, but in some cases may include entering the location data in the form of particular reference system coordinates (e.g., latitude and longitude). In many cases, however, location data is entered in the form of a full or partial street address. While a street address format incorporates familiar and well-known location descriptions (especially when compared to, e.g., latitude and longitude descriptions), this approach also presents some drawbacks. For example, user syntax can vary widely, leading to the need to account for multiple expressions of similar location data (e.g., first vs. 1^{st}, avenue vs. ave, etc.). In addition, manual entry of long address strings (necessary for a desired level of specificity) is prone to mistake. To reduce these types of errors, mapping systems in many cases implement a step-by-step entry approach (e.g., enter state, then city, then street name, then street number, etc.), in which the data entered at each step can be verified or limited. While this approach can reduce manual data entry errors, it also can lead to a somewhat cumbersome and time-consuming process. Additionally, as new addresses are created databases can become out of date and be unable to find these addresses.

### SUMMARY

Embodiments of the invention generally provide systems and methods for generating and/or using location identification codes that reference specific locations within a geographical region of interest.

According to one aspect of the invention, a computer program product and/or computer-readable storage medium is provided with software for generating location identification codes. The storage medium has executable instructions for causing a programmable processor to execute a method for generating location identification codes for referencing locations within a geographic region. The method includes receiving a geographic region selection and receiving a definition of a standard areal unit. The standard areal unit represents a smallest identifiable subset of the geographic region to be identified by a particular location identification code. The executable method also includes determining a total number of the standard areal units in the geographic region and determining a number of character positions in the location identification code. The number of character positions is based on the total number of the standard areal units in the geographic region and also based on a predetermined set of characters. The executable method also includes generating the location identification code for at least one standard areal unit in the geographic region. The location identification code includes a character from the predetermined set of characters in one or more of the number of character positions.

Another aspect of the invention provides an interactive mapping system. The mapping system includes an input device, an output device, one or more computer-readable storage mediums, and one or more programmable processors. The one or more processors are programmed with the executable instructions stored on the storage mediums, which enable the processor(s) to carry out one or more functions of the mapping system. The processor(s) are programmed to receive a location identification code from the input device, retrieve a location description using the location identification code, display the location description using the output device, and retrieve and display map data corresponding to the location identification code on the output device. The location identification code identifies one of a plurality of standard areal units within a geographic region of interest. The location identification code has a number of character positions based on 1) a total number of the plurality of standard areal units within the geographic region of interest and 2) a predetermined set of characters.

According to another aspect of the invention, a method for providing map data is provided. The method includes entering a location identification code into a computer processor based interactive mapping system. The mapping system includes at least one programmable processor, one or more computer-readable storage mediums programmed with computer-executable instructions, and an electronic display. The location identification code identifies one of a plurality of standard areal units within a geographic region of interest. The location identification code is a positional numeral having a first base and a number of character positions. The number of character positions are determined according to 1) a total number of the plurality of standard areal units within the geographic region of interest and 2) a predetermined set of characters for generating the location identification code. The first base of the location identification code is a total number of characters in the predetermined set of characters. The method also includes using the programmable processor(s) to convert the location identification code to an index having a second base and retrieve reference coordinates corresponding to the index from at least one of the computer-readable storage mediums. The method also includes retrieving a location description based on the location identification code from at least one of the computer-readable storage mediums and displaying the location description on the electronic display for validation by a system user. The method also includes retrieving map data from at least one of the computer-readable storage mediums using the reference coordinates and displaying the map data on the electronic display.

Embodiments of the present invention can provide one or more of the following features and/or advantages. In certain embodiments, a method includes receiving a definition of the predetermined set of characters. The predetermined set of characters can comprise alphanumeric and/or special characters in some cases. In certain cases the predetermined set of characters consists of only consonants and numbers. For example, in some cases selecting only certain consonants and numbers can provide a desired degree of flexibility while also decreasing the likelihood of typing mistakes and/or use of recognizable words. According to an embodiment, a predetermined set of characters consists of {B G H J L MN P R T V W X Y Z 4 6 7 8}. In some cases the location identification code is a positional numeral having a base determined by the total number of characters in the predetermined set. Certain embodiments provide multiple location identification codes for a single standard areal unit, which allows the embodiment to identify the areal unit at different altitudes. Further, in some cases standard reference coordinates can be paired/matched with location identification codes and easily referenced with the location identification codes. The reference coordinates can provide an interface between the location identification codes and a mapping engine/application, allowing an operator to use a location identification code to access map data normally only accessible with a reference coordinate, street address, or the like.

These and various other features and advantages will be apparent from a reading of the following detailed description.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a flow diagram illustrating a method of generating location identification codes according to an embodiment of the invention.

FIG. 2 is a representation of a geographic region divided into standard areal units according to an embodiment of the invention.

FIG. 3 is a block diagram illustrating an interactive mapping system according to an embodiment of the invention.

FIG. 4 is a flow diagram illustrating a method of using a location identification code according to an embodiment of the invention.

FIGS. 5A-5D are depictions of a user interface useful for entering location identification codes according to an embodiment of the invention.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Various embodiments provide improvements related to interactive computer-based maps, geographic location identification, navigation, and/or direction assistance among other things. Some embodiments, for example, enable interactive mapping using novel location identification techniques and identification code generation and referencing. In some cases embodiments provide a unique manner of interfacing with mapping software applications in multiple environments, such as mapping applications that are PC-based, internet-based, provided through a multi-purpose hand-held device (e.g., PDA, smart phone) or provided in hardware with dedicated functionality, such as a navigation device.

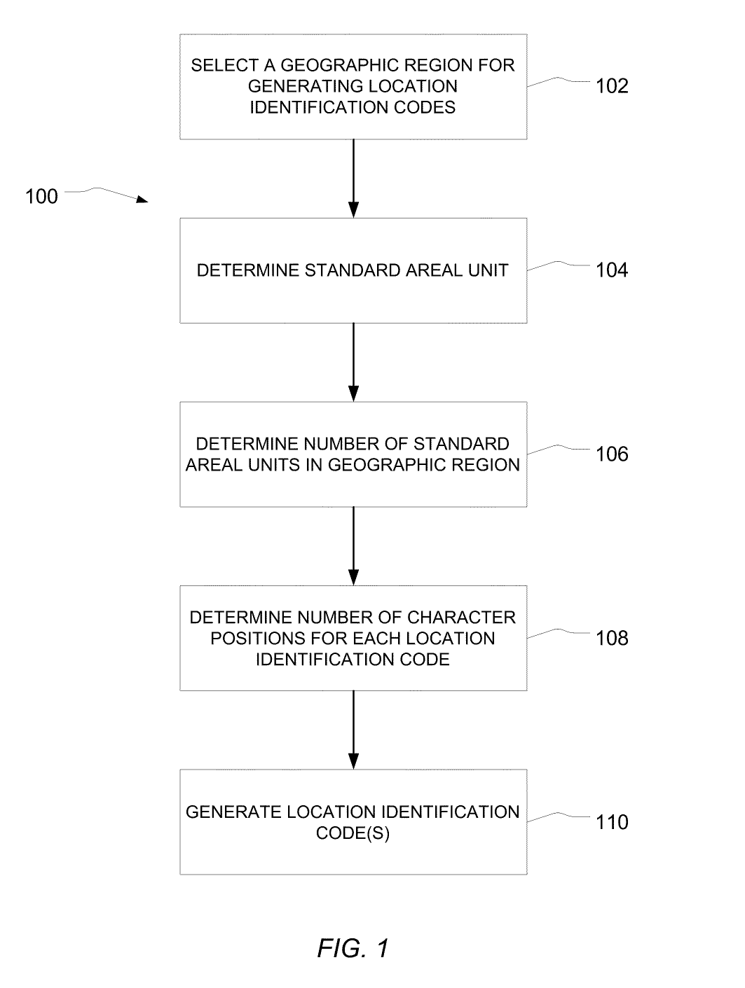

Turning to FIG. 1, a method 100 of generating location identification codes is illustrated according to an embodiment of the invention. Such a method may be carried out and found useful to a wide variety of users. For example, a user could be any person or organization desiring the ability to create a proprietary or distinct location identification system. As just one example, a governmental authority may find the method 100 useful for creating officially-sanctioned location identification information. Another example can include corporations or other organizations seeking the ability to uniquely identify multiple locations within a defined geographical area. For example, a real estate company (or collection of real estate companies) may utilize an embodiment of the invention to create a proprietary location identification system that allows the company's clients and employees to easily identify and/or travel to one or more properties (e.g., commercial and/or residential) listed by the real estate company in a particular geographic location. Of course a wide variety of other potential users are also possible and the scope of the invention is not limited in this regard.

The method 100 is preferably carried out with the use of a processor-based device programmed with instructions for executing the method 100. For example, the method of generating location identification codes may in some cases be provided as part of an interactive software mapping application. In some embodiments a (non-transitory) computer program product such as a CD, DVD, disk drive, solid state memory, or other such computer-readable storage medium is programmed with executable instructions that allow a programmable processor to carry out the method 100.

The method 100 includes selecting a geographic region of interest 102, determining a standard areal unit 104 that represents a discrete, identifiable subset of the geographic region, determining the number of standard units within the geographic region 106, determining a number of character positions in a particular location identification code 108, and generating the location identification codes for one or more standard areal units 110. In some embodiments in which the geographic region and/or standard areal unit are predetermined, the method may only include determining the number of standard units 106, determining a number of character positions 108, and generating the location identification codes 110.

The selected geographic region can be any region of interest regardless of size or terrain. As just a few examples, the region of interest may encompass a city, neighborhood, state, country, continent, hemisphere, or the entire world. Of course, any desired geographic region can be selected, and selectivity is not limited to geographic regions having formally defined boundaries. In certain embodiments, the method 100 includes receiving a selection of a geographic region of interest already made by a system user. For example, a person setting up a mapping system may select the geographic region of interest and then input the selection into mapping software where it is received.

Continuing with reference to FIG. 1, the method 100 also includes determining or defining the standard areal unit 104 within the geographic region. In general, the standard areal unit represents the smallest identifiable subset of the geographic region to be identified by a location identification code. One or more factors may be considered when defining the standard areal unit, including for example, the overall size and shape of the selected geographic region, the desired granularity or resolution of the system, and/or contemplated characteristics of the location identification code itself, such as the number of character positions within the location identification code. Defining the standard areal unit 104 may in some cases include setting both a size and a shape of the standard unit. For example, in some embodiments, the geographic region may be divided up into a number of equally-sized standard areal units of square configuration. The size of the standard unit may vary considerably. As just one example, a length of a standard areal unit may range from 10 feet to 100 feet. In some cases, smaller or larger dimensions may be used. The method 100 may additionally or alternatively include receiving the definition of the standard areal unit from, e.g., a system user, rather than automatically setting the parameters of the standard unit. For example, a system user may use a mapping software application to define the standard areal unit, which is then received and stored for future use by the software application.

Upon determining the standard areal unit, the processor executing the method determines the total number of standard units within the selected geographical region 106. This step provides an indication of the total number of location identification codes that will be necessary in order for each standard areal unit to be assigned a unique location identification code. The number of standard units can be determined to any desired degree of accuracy, and in some embodiments the number of standard areal units may be estimated based on approximate boundaries of the geographic region.

In certain embodiments one or more altitudes may also be identified for a particular areal unit. For example, a particular location identification code may represent both a geographic location on a two-dimensional map and a certain altitude, or group of altitudes (e.g., representing a standard volume), above the geographic location. Altitude can be measured from any suitable reference point, such as mean sea level. Thus, the location identification code can be a three-dimensional code that identifies a location in three-dimensional space. According to some embodiments, the three-dimensional location identification codes could be utilized in air traffic control applications. Complimentary to the FAA's Next Generation Air Transportation System (NextGen), and the Automatic dependent surveillance-broadcast (ADS-B), aircraft could be vectored to three-dimensional coordinates using three-dimensional location identification codes. Additionally, these coordinates could be part of airport approach procedures. Various portions of the approach procedures (for example, initial approach fix, actual runway) could be represented by a location identification code.

Continuing to refer to FIG. 1, the computer-executable method 100 also includes determining the number of character positions desirable for each location identification code 108. The total number of character positions within the location identification code is one factor in determining the total number of unique location identification codes available for use. A number of factors can be used to determine the number of character positions 108 depending upon the desired implementation of the invention. In some embodiments, a minimum number of character positions is driven by a desired resolution of the system. In this case the desired resolution is first set and the minimum number of unique location identification codes needed for the resolution is determined. Upon determining the minimum number of unique location identification codes, the number of character positions can be set to assure the desired degree of resolution.

In some embodiments, the length (i.e., number of positions) of the location identification code may be set based on other factors, such as available memory, processing power, aesthetics, ease of use, etc. For example, it may be desirable to implement an eight-character code, limiting a location identification code to eight character positions. In this case, the minimum (and/or maximum) number of character positions is determined first, and the available resolution of the system may vary within the limits set by the number of available unique location identification codes.

The number of character positions in the location identification code may also depend upon the properties of a particular character set. According to some embodiments, the method 100 also includes receiving a definition of a predetermined set of characters as determined by, e.g., a system user. In some cases the location identification code is a positional numeral of M character positions, having a base N defined by the total number of characters in the predetermined set of characters. Thus, the number of unique location identification codes available in such a system is equal to N^{M}. Accordingly, the number of characters within the character set and/or the number of character positions within the location identification code may be varied to achieve greater or lesser degrees of resolution. For example, in some embodiments location identification code base N is 19, while the number of character positions M is 8; in another embodiment, N may be 11 and M may be 6. It should be appreciated that N and M can be a variety of numbers, and that embodiments of the invention are not limited to any specific configuration.

According to some embodiments of the invention, the character set of available characters may include any combination of alpha, numeric, alphanumeric and/or other desirable characters or symbols. In some embodiments, the specific characters included in the set are determined based on one or more factors. For example, easily transposed, mistaken, or misinterpreted symbols may be left out of the set (e.g., S and 5; 1, 1, and I; 9 and g; etc.). In some embodiments, the character set may exclude certain letters, such as vowels, to make it difficult to accidentally or purposely form undesirable (e.g., embarrassing or profane) words. For example, in some embodiments the set of characters may consist only of consonants and some numbers. One exemplary set of characters is {B G H J L M N P R T V W X Y Z 4 6 7 8}.

Returning to FIG. 1, after determining the number of standard areal units within the selected geographic area and the number of character positions within each location identification code, the method 100 includes generating a location identification code for one or more standard areal units 110 in the selected geographic region. Each location identification code includes a character of the predetermined set in at least one and possibly multiple character positions of the code.

The generation of location identification codes can proceed in a variety of manners. In some embodiments the system administrator simply generates an adequate number of unique location identification codes and then assigns one to each individual standard areal unit within the geographic region. This method provides a predetermined setup in which system users only need to determine a standard areal unit of interest and then look up the pre-assigned location identification code. In another embodiment, an index number is initially assigned to each standard areal unit. For example, the areal units may be sequentially numbered in an easily recognizable base, such as base 10. In this case the method 100 can include determining the index of a particular areal unit and then generating a location identification code for the unit based on the index. In certain embodiments this involves converting the index, which may be in a first base, to a location identification code in a second base (e.g., base 19, as described above). Upon completion of this process, the standard areal units are sequentially numbered with location identification codes in the second base.

Having described a number of aspects of embodiments of the invention with respect to FIG. 1, an example of one embodiment of the invention is discussed below.

Step 1: Select Geographic Region of Interest. By way of example, the continental United States is selected as the subject geographic region of interest.

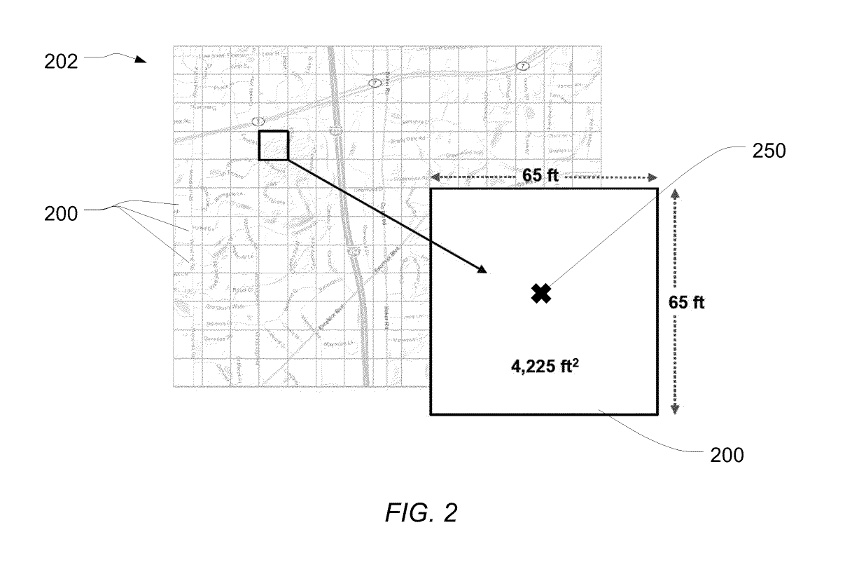

Step 2: Determine Standard Areal Unit. Referring to FIG. 2, in the example a unit length of 65 feet is selected and a unit width of 65 feet is selected, yielding a standard areal unit 200 for the geographic region 202, having a square configuration of 4,225 square feet.

Step 3: Determine Number of Standard Areal Units. The continental United States is approximately 2,500 miles wide (east to west) and 1,000 miles high (north to south). Using standard square units of 4,225 ft², there are about 16,496,094,675 square units in the region.

Step 4: Determine Number of Character Positions. The number will in part depend upon the predetermined set of characters used. One example is a system using a total of 19 characters consisting of the set {B G H J L M N P R T V W X Y Z 4 6 7 8}. In this example, vowels and commonly transposed numbers and digits have been removed. Using these 19 characters, the selected geographic region (i.e., the continental United States in this example) can be represented by location identification codes having 8 total character positions (19⁸=16,983,563,041 which is greater than the number of standard areal units from step 3).

Step 5: Generate Location Identification Codes. In a first step, a base-10 (e.g., 16,496,094,675) index number is assigned to each standard unit, and then in a second step, the base-10 index is converted to its respective base-19 (e.g., B4RTMVTG) location identification code.

Embodiments of the invention implementing a location identification code scheme as previously described can be used in a number of manners. In some embodiments the previously described methods (and systems performing the methods) may be used independently of other systems in order to create standalone geographic referencing schemes. In some embodiments, the generated location identification codes are incorporated into a more sophisticated computer-based mapping application, such as a map engine or GPS navigation system.

Location identification code systems created according to certain embodiments of the invention may also be useful for a wide variety of end users. Use of location identification codes may be particularly advantageous for frequent travelers, people visiting multiple locations in the same region, or those traveling in unfamiliar geographic regions. For example, prospective lessees and/or purchasers may find using simple location identification codes as described herein to be a simple and fast way to locate multiple real estate properties. As another example, package/letter shipping, mailing, and/or delivery services may use location identification codes for representing the locations of senders and/or recipients, enabling simple and efficient location identification and delivery service. Of course, such location identification systems may generally be useful for anyone seeking to identify a particular location within a geographic region, and the scope of the invention is not limited in this regard.

In addition to providing the capability to identify standard areal units within a geographic area using the location identification codes, the location identification codes can also be used to retrieve corresponding location information in other coordinate systems. For example, the location identification code system can be used in conjunction with a reference coordinate system, such as geodetic latitude and longitude. In some embodiments, when each location identification code is assigned to a specific standard unit, the location identification code may also be associated with a geographical point within the standard unit (e.g., center of unit, lower-right corner, etc.), along with associated latitude and longitude coordinates for the specific point. For example, referring to FIG. 2, in some cases a location identification code is associated with a center point 250 of the standard areal unit and the specific latitude and longitude coordinates for the point 250. Upon entering the location identification code into an interactive mapping application, the application can convert or look-up the location identification code to determine the reference coordinates associated with the location identification code. The application can then utilize the reference coordinates to provide customary functionality, such as mapping, generating directions, etc., as is known in the art.

In describing various embodiments of the invention, many aspects of the embodiments are discussed herein in terms of functionality, in order to more particularly emphasize their implementation independence. Embodiments of the invention may be implemented using a combination of hardware, firmware, and/or software. For example, in many cases some or all of the functionality provided by embodiments of the invention may be implemented in executable software instructions capable of being carried on a programmable computer processor. Likewise, some embodiments of the invention include a computer-readable storage medium on which such executable software instructions are stored.

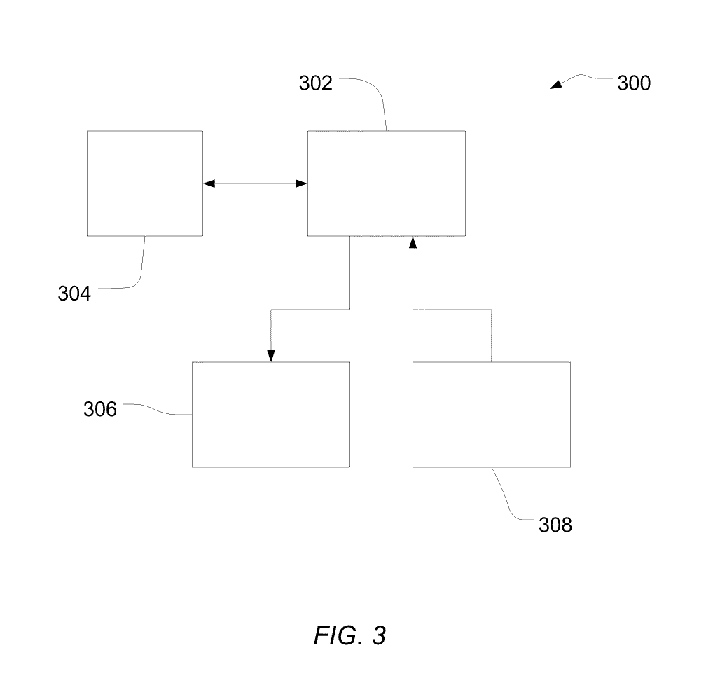

FIG. 3 is a block diagram providing a simplified view of an interactive mapping system 300 according to one embodiment of the invention. The system 300 is generally driven by a computer processor 302, which executes machine-readable instructions to provide the functionality in certain embodiments of the invention. The processor 302 can be any suitable programmable processor that is capable of executing coded instructions. For example, the processor 302 may be a microprocessor, or a special-purpose processor designed specifically for the mapping system 300. The system 300 includes the processor 302 electrically coupled to a non-transitory computer-readable storage medium 304. The storage medium 304 can comprise any of a wide variety of forms of non-transitory (i.e., physical material) storage mediums, such as disks, CDs, DVDs, solid state memory, and the like.

The system 300 also includes an input device or module 308, which may be provided in any suitable form. For example, the input device 308 can include a keypad, keyboard, pointing device, touch screen, or a communication line connected to the processor 302 in order to forward inputs to the processor. The mapping system 300 also includes an output device 306, such as an electronic display, in communication with the processor 302 for receiving and displaying electrical signals representative of data to be displayed to a system user. The system 300 may include a wide variety of other components not shown in FIG. 3. Communication between modules may be provided in any suitable form, such as wired and/or wireless.

Although not shown, components of the mapping system 300 may be incorporated into a single device, such as personal computing devices, desktop or laptop computers, personal digital assistants (PDAs), mobile telephones, and/or GPS navigation units, to name a few. In certain embodiments, the mapping system 300 may include multiple processors and memory components and/or may be distributed across a network or across multiple locations. For example, a remote server having one or more processors and memory components may host an interactive mapping application that is accessible from one or more other devices, such as a PC or a smart phone.

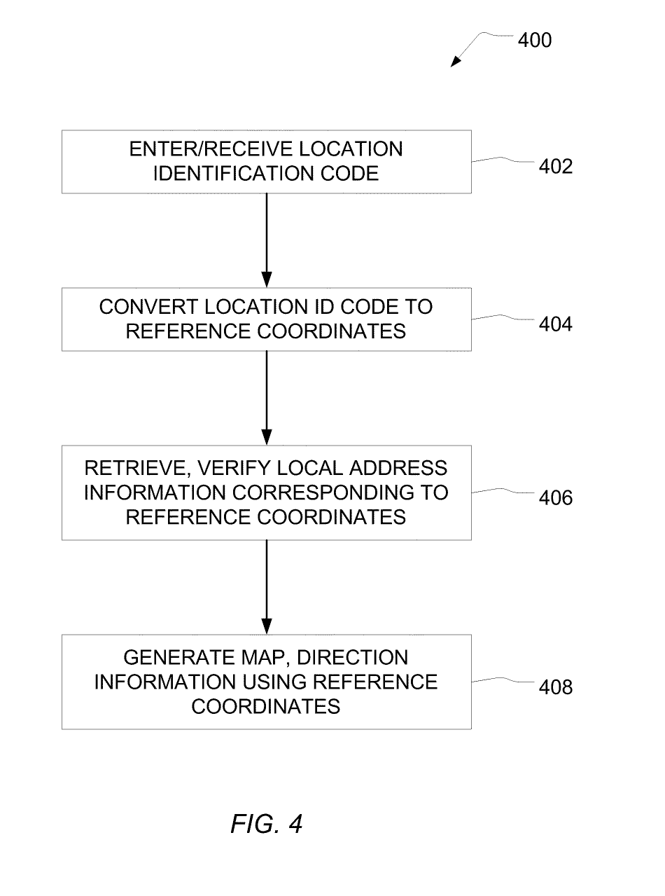

FIG. 4 illustrates one example of an implementation of a location identification code system within an interactive mapping system. Referring to FIG. 4, the implemented method 400 comprises entering and/or receiving a location identification code into the system 402. For example, a user may type in or scan in a location identification code corresponding to a specific location the user would like to identify. The method optionally includes converting the location identification code to a set of reference coordinates 404. The reference coordinates may correspond to a representative geographical point within the standard areal unit. For example, referring to FIG. 2, the reference coordinates may refer to a center point 250 of the standard areal unit 200. The location identification code and/or reference coordinates are then used to retrieve a location description, such as local address information corresponding to the reference coordinates and location identification code. The location description (in this case the local address) can then be displayed using a system output device (see, e.g., FIG. 3) for verification 406 or validation by a system user. Once it is determined that a correct location identification code has been entered corresponding to a desired location, the method includes retrieving and displaying map data corresponding to the entered location identification code. For example, when used as part of an interactive mapping system, the mapping system may generate a map and/or direction information using the reference coordinates 408.

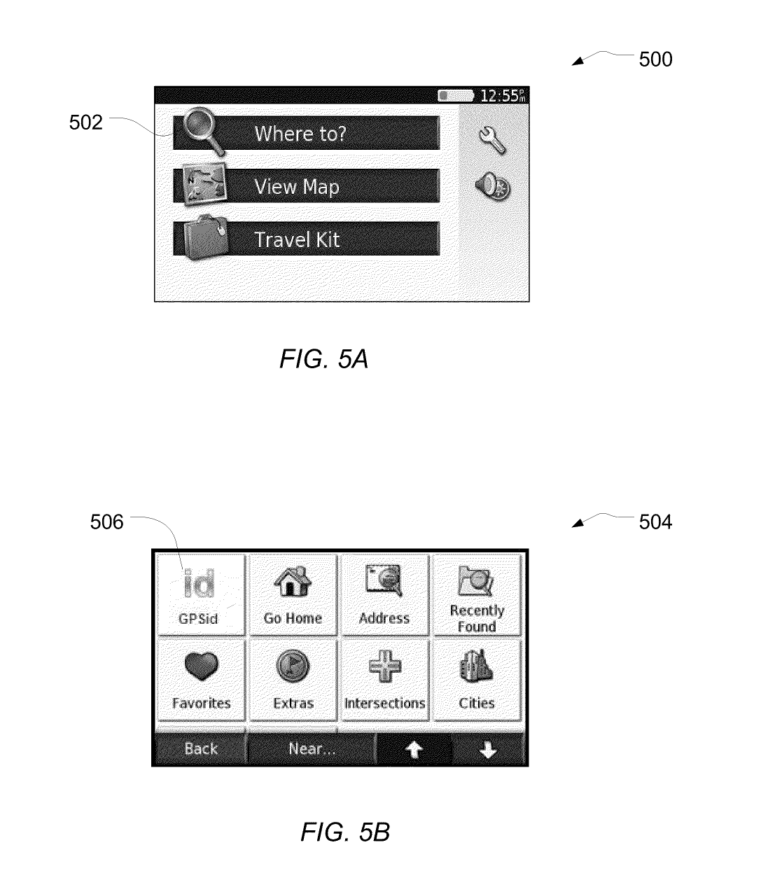

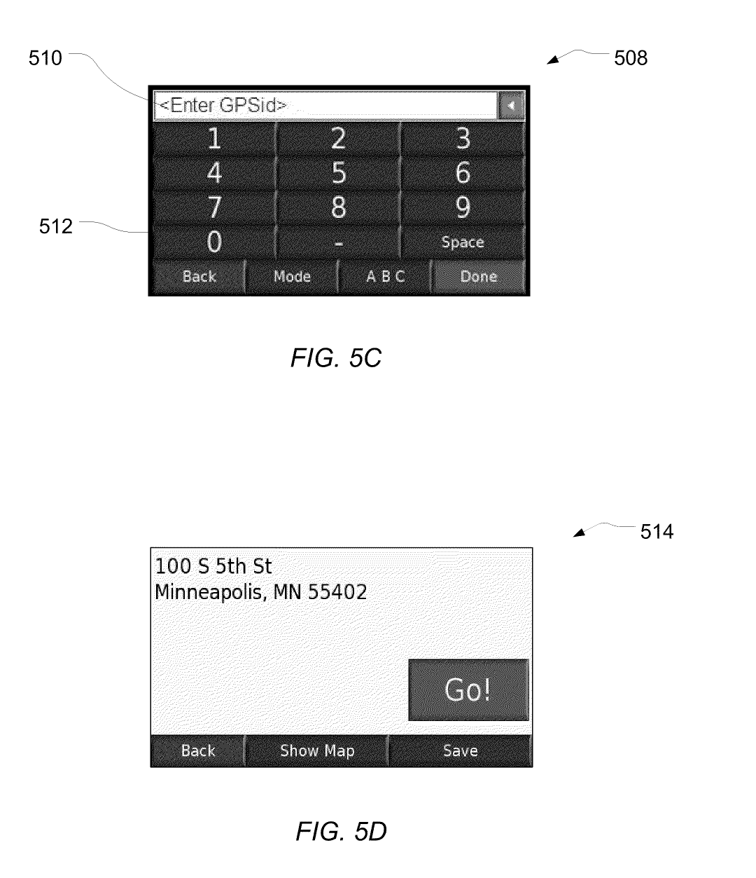

FIGS. 5A-5D illustrate one example of a user interface for a computer-based interactive mapping system in the form of a GPS navigation system. At an initial decision screen 500, a user can select an option 502 to manually enter location information into the mapping system. A next screen 504 provides a number of options for entering information, including a button 506 for entering location identification codes. Pressing the location identification button 506 brings up a data entry screen 508, in which the user can enter the location identification code (called a GPSid in this example) using a keyboard 512. Upon entering the code, the system converts the location identification code to reference latitude and longitude, recalls an approximate street address for the coordinates, and displays the street address for verification. After checking the accuracy of the output, a user can then select “Go!” to generate map and/or direction information.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A computer-readable storage medium comprising executable instructions for causing a programmable processor to execute a method for generating location identification codes for referencing locations within a geographic region, the method comprising:
receiving a geographic region selection;
receiving a definition of a standard areal unit representing a smallest identifiable subset of the geographic region to be identified by a location identification code;
determining a total number of the standard areal units in the geographic region;
determining a number of character positions in the location identification code based on the total number of the standard areal units in the geographic region and a predetermined set of characters; and
generating the location identification code for at least one standard areal unit in the geographic region, the location identification code comprising a character from the predetermined set of characters in one or more of the number of character positions.

2. The medium of claim 1, wherein the method further comprises receiving a definition of the predetermined set of characters.

3. The medium of claim 1, wherein the location identification code is a positional numeral having a base and wherein a total number of characters in the predetermined set of characters is the base.

4. The medium of claim 1, wherein the predetermined set of characters consists of consonants and numbers.

5. The medium of claim 4, wherein the predetermined set of characters consists of {B G H J L M N P R T V W X Y Z 4 6 7 8}.

6. The medium of claim 1, wherein the method further comprises assigning each of the standard areal units an index.

7. The medium of claim 6, wherein the method further comprises determining the index of the at least one standard areal unit and generating the location identification code based on the index.

8. The medium of claim 7, wherein the index has a first base, the location identification code has a second base and generating the location identification code comprises converting between the first base and the second base.

9. The medium of claim 1, wherein determining the number of character positions is further based on a number of altitudes for the standard areal units and wherein the method further comprises generating multiple location identification codes for the at least one standard areal unit, each of the multiple location identification codes corresponding to a separate altitude for the at least one standard areal unit.

10. An interactive mapping system, comprising:
an input device;
an output device;
one or more computer-readable storage mediums comprising executable instructions; and
one or more programmable processors programmed with the executable instructions to
receive a location identification code from the input device,
retrieve a location description using the location identification code,
display the location description using the output device, and
retrieve and display map data corresponding to the location identification code on the output device,
wherein the location identification code identifies one of a plurality of standard areal units within a geographic region of interest and
wherein the location identification code has a number of character positions based on a total number of the plurality of standard areal units within the geographic region of interest and based on a predetermined set of characters for generating the location identification code.

11. The interactive mapping system of claim 10, wherein the one or more programmable processors are further programmed to determine reference coordinates based on the location identification code.

12. The interactive mapping system of claim 11, wherein the reference coordinates for the location identification code correspond to a representative geographical point within the standard areal unit corresponding to the location identification code.

13. The interactive mapping system of claim 10, wherein the location identification code is a positional numeral having a base and wherein a total number of characters in the predetermined set of characters is the base.

14. The interactive mapping system of claim 10, wherein the one or more programmable processors are further programmed to convert the location identification code to an index and use the index to retrieve the location description.

15. The interactive mapping system of claim 14, wherein the index has a first base, the location identification code has a second base and converting the location identification code to the index comprises converting between the second base and the first base.

16. The interactive mapping system of claim 10, wherein the predetermined set of characters for generating the location identification code consists of consonants and numbers.

17. The interactive mapping system of claim 16, wherein the predetermined set of characters consists of {B G H J L M N P R T V W X Y Z 4 6 7 8}.

18. The interactive mapping system of claim 10, wherein the location identification code corresponds to one of a plurality of altitudes for the one of the plurality of standard areal units.

19. A method for providing map data, comprising:
entering a location identification code into a computer processor based interactive mapping system comprising
at least one programmable processor,
one or more computer-readable storage mediums programmed with computer-executable instructions, and
an electronic display,
the location identification code identifying one of a plurality of standard areal units within a geographic region of interest and comprising a positional numeral having a first base and a number of character positions determined according to
1) a total number of the plurality of standard areal units within the geographic region of interest and
2) a predetermined set of characters for generating the location identification code, wherein the first base of the location identification code is a total number of characters in the predetermined set of characters;
converting the location identification code to an index having a second base with the at least one programmable processor;
retrieving reference coordinates corresponding to the index from at least one of the one or more computer-readable storage mediums;
retrieving a location description based on the location identification code from at least one of the one or more computer-readable storage mediums;
displaying the location description on the electronic display of the interactive mapping system for validation by a system user; and
retrieving map data from at least one of the one or more computer-readable storage mediums using the reference coordinates and displaying the map data on the electronic display.

20. The method of claim 19, wherein the predetermined set of characters consists of consonants and numbers.
